(19) United States
(12) Patent Application Publication
(10) Pub. No.: US 2007/0267425 A1
(43) Pub. Date: Nov. 22, 2007

(54) Dispenser device

(76) Inventor: Yoram Gill, Haifa (IL)

Correspondence Address: PEARL COHEN ZEDEK LATZER, LLP, 1500 BROADWAY 12TH FLOOR, NEW YORK, NY, 10036, US

(21) Appl. No.: 11/698,989

(22) Filed: Jan. 29, 2007

Related U.S. Application Data
(60) Provisional application No. 60/762,527, filed on Jan. 27, 2006.

(51) Int. Cl. B67D 3/02

(52) U.S. Cl. 220/709

(57) ABSTRACT

A dispenser device for dispensing liquid form a bottle or container having a neck onto which a cap can be fitted is disclosed. The device comprises a cap adapted to be fitted to the neck, the cap provided with an opening; a drinking tube having a distal end and proximal end, the proximal end fluidically connected to the opening of the cap; and an adjustable feed tube having a proximal end and a distal end, the proximal end inserted into the proximal end of the drinking tube, the feed tube adapted to be moved at least partially in and out of the drinking valve and through the opening of the cap, so as to allow adjusting the length of the feed tube that is inserted inside the bottle.

### CROSS REFERENCE TO RELATED APPLICATIONS

This application claims priority from U.S. Provisional Patent Application No. 60/762,527, filed on Jan. 27, 2006, which is incorporated in its entirety herein by reference.

### FIELD OF THE INVENTION

The present invention relates to drinking aids. More particularly it relates to a dispenser adapted to be coupled to a bottle or other drink containers for dispensing drinks contained in the bottle or container.

### BACKGROUND OF THE INVENTION

The human need to migrate in the early days of history brought about the need to find solutions for water and liquid transportation that was to be both convenient and safe. The solution was to carry water in bags made of animal hide, known as waterskins, on journeys, as it was inconvenient to carry around clay jugs or other rigid vessels.

In the beginning of the 20th century however it was more customary to use rigid metal vessels for the transport of liquids, such as the tin water flask, gasoline jerricans, buckets and barrels.

As plastic products started to appear, around the middle of last century, it took over from metal and became widely in use in the manufacturing of rigid liquid vessels.

Furthermore as plastic production techniques evolved improved flexible liquid vessels were introduced. Examples are infusion or blood bags used in hospitals, milk bags and ketchup or mustard bags used in fast food restaurants.

Many hydration systems are available today with a dispensing tube that is connected to liquid container of the system and allows the user to drink from the container while on the move (usually through a mouthpiece that is attached to the tube), improving performance and reducing the risk of dehydration. See, for example, U.S. Pat. No. 4,526,298 (Boxer et al.), U.S. Pat. No. 6,032,831 (Gardner et al.), U.S. Pat. No. 6,247,619 (Gill et al.), U.S. Pat. No. 6,749,090 (Bailey), U.S. Pat. No. 6,908,015 (Choi et al.).

Such hydration systems are mainly used in outdoor sports and recreational activities, such as mountaineering, jogging, cycling etc. However, the general public is not so exposed to these products, and many people that occasionally engage in recreational activities still prefer to refrain from obtaining costly hydration system for occasional use and instead carry conventional bottles of beverages or even buy them on location.

It is an object of the present invention to provide a dispenser adapted to be coupled to a commonly available bottle or other containers, allowing a user to drink from the bottle or container as he or she would from a hydration system with a dispensing tube (i.e. on the move).

Other objects and advantages of the present invention will become apparent after reading the present specification and consulting the accompanying drawings.

### SUMMARY OF THE INVENTION

There is thus provided, in accordance with some preferred embodiments of the present invention, a dispenser device for dispensing liquid from a bottles or a container having a neck on which a cap that can be fitted, the device comprising:

a cap adapted to be fitted to the neck, the cap provided with an opening;

a drinking tube having a distal end and proximal end, the proximal end connected to the opening of the cap; and

an adjustable feed tube having a proximal end and a distal end, the proximal end inserted into the proximal end of the drinking tube, the feed tube adapted to be moved at least partially in and out of the drinking tube and through the opening of the cap, so as to allow adjusting the length of the feed tube that is inserted inside the bottle.

Furthermore, in accordance with some preferred embodiments of the present invention, drinking tube is provided drinking valve coupled to the distal end of the drinking tube.

Furthermore, in accordance with some preferred embodiments of the present invention, the cap is provided with a one-way valve for pressure release.

Furthermore, in accordance with some preferred embodiments of the present invention, the device is further provided with at least one adapter for connecting the cap to the neck.

Furthermore, in accordance with some preferred embodiments of the present invention, the adapter has an internal thread for fitting onto a corresponding external thread on the neck and an external thread for fitting into a corresponding internal thread of the cap.

Furthermore, in accordance with some preferred embodiments of the present invention, the adapter has an external thread for fitting into a corresponding internal thread on the neck and an external thread for fitting into a corresponding internal thread of the cap.

Furthermore, in accordance with some preferred embodiments of the present invention, a plurality of adapters designed for necks of different sizes is provided.

Furthermore, in accordance with some preferred embodiments of the present invention, a universal adapter is provided for connecting the cap to necks of different sizes.

Furthermore, in accordance with some preferred embodiments of the present invention, the cap is provided with a flange extending over the opening on which the drinking tube is fitted.

Furthermore, in accordance with some preferred embodiments of the present invention, a portion of the drinking tube at the proximal end is reinforced so as to prevent kinking of the tube.

Furthermore, in accordance with some preferred embodiments of the present invention, the universal adapter comprises at least one other cap with means for providing a hole in said at least one other cap for fitting with the cap.

Furthermore, in accordance with some preferred embodiments of the present invention, the means for providing a hole comprises one or more punches.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1a illustrates an adjustable dispenser device, according to a preferred embodiment of the present invention, mounted on a bottle that has a neck that fits the thread of the cap of the device.

FIG. 1b illustrates the dispenser device shown in FIG. 1a, mounted on a smaller bottle, which has a different neck that does not fit the cap of the device.

FIG. 2a illustrates the dispenser device shown in FIG. 1a, with its feeding tube almost fully extended.

FIG. 2b illustrates the dispenser device shown in FIG. 1a, with its feeding tube partially extended.

FIG. 2c illustrates the dispenser device shown in FIG. 1a, demonstrating built-in protection against kinking of the drinking tube.

FIG. 3 illustrates a sectional view of a dispenser device according to a preferred embodiment of the present invention.

FIG. 4a illustrates a sectional view of a cap incorporated with a dispenser device in accordance with a preferred embodiment of the present invention (the encircled area in FIG. 3).

FIG. 4b illustrates a detail of a cap according to a preferred embodiment of the present invention (the encircled detail of FIG. 2a).

FIG. 4c illustrates a sectioned detail of a cap according to a preferred embodiment of the present invention.

FIG. 5a illustrates a cap for a dispenser device according to a preferred embodiment of the present invention.

FIG. 5b illustrates a cap for a dispenser device according to a preferred embodiment of the present invention, with an adapter.

FIG. 5c illustrates an alternative adapter for use with a dispenser device according to a preferred embodiment of the present invention.

FIG. 5d illustrates an adapter to be used in conjunction with a cap for a dispenser device according to a preferred embodiment of the present invention.

### DETAILED DESCRIPTION OF PREFERRED EMBODIMENTS

The present invention is aimed at providing a dispenser device adapted to be coupled to existing bottles and containers, which have a neck opening with a thread (originally for threading the original cap of the bottle or container onto the opening). The present invention allows reuse of otherwise non-reusable bottles and containers in which drinks are commercially sold. Instead of throwing the non-reusable bottle to the waste bin, the bottle is, with the aid of the device of the present invention, ready to be reused. The user of the device of the present invention is, in fact, offered an inexpensive version of a hydration system that can be used for out-door activities, and which typically comes equipped with a drinking tube and a dispensing valve.

The dispenser generally comprises a replacement cap, for replacing the original cap of the bottle or container, a drinking tube, which is preferably equipped with a mouthpiece and an adjustable feed tube that is fluidically connected to the drinking tube and which may be extended or retracted in order to reach the bottom of the bottle or the container that the device is attached to.

In some embodiments of the present invention an adapter is provided so as to facilitate fitting of the device of the present invention onto a variety of bottles and containers. In other embodiments of the present invention a universal fitting is available, taking into account that many drink bottles (such as coca-cola™. Pepsi™, mineral water of various firms) present a neck with a typical thread of 28 mm in diameter. The cap of a device according to a preferred embodiment is designed to fit that thread, while one or more adapters are optionally provided for fitting to bottle necks with other thread diameter.

Reference is made to the figures accompanying this specification.

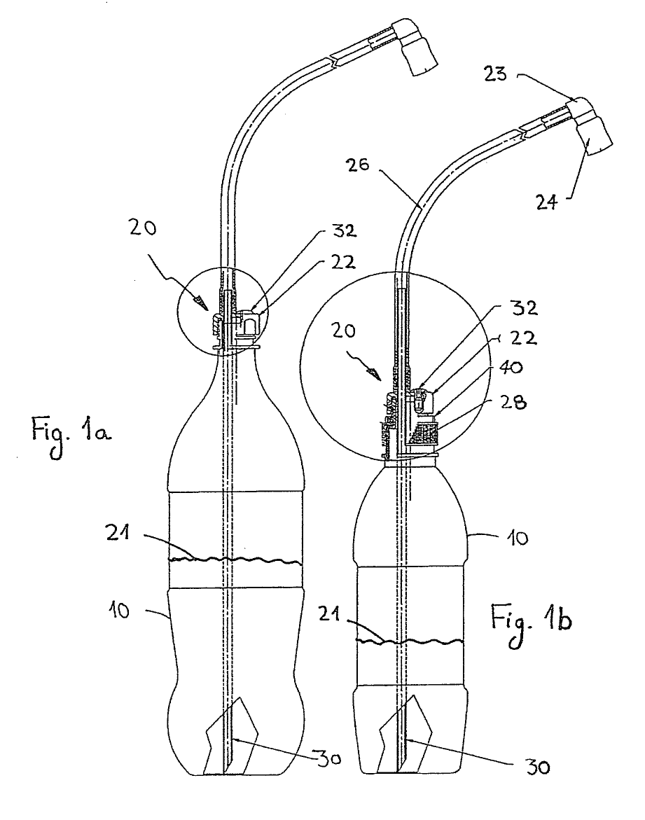

FIG. 1a illustrates an adjustable dispenser device, according to a preferred embodiment of the present invention, mounted on a bottle that has a neck that fits the thread of the cap of the device. The dispenser device 20 comprises a drinking tube 26 coupled to cap 22, and adjustable feed tube 30, that is partially threaded through drinking tube 26 and extends through cap 22 into bottle 10. Drinking tube 26 is preferably provided with a drinking mouthpiece (here bite valve 24 that is coupled to the tube via connector 23). One way valve 32 is optionally provided (see further explanation hereinafter).

FIG. 1b illustrates the dispenser device shown in FIG. 1a, mounted on a smaller bottle. It may be appreciated that when the bottle 12 is smaller the adjustable feed tube 30 needs to be retracted, so that a longer portion is inserted into the drinking tube 26. The ability of the adjustable feed tube to be extended or retracted helps adjust its position and place the end of the tube as close as possible to the bottom of the bottle and thus ensure the user may properly empty the bottle.

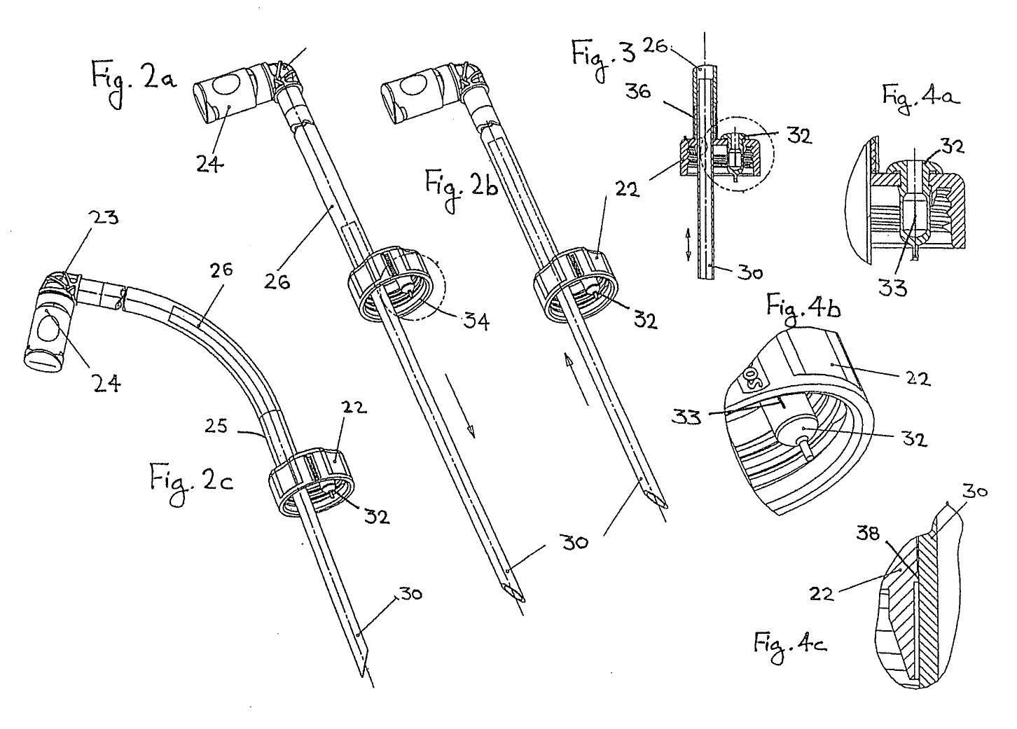

FIG. 2a illustrates the dispenser device shown in FIG. 1a, with its feeding tube 30 almost fully extended. FIG. 2b illustrates the dispenser device shown in FIG. 1a, with its feeding tube 30 partially extended. FIG. 2c illustrates the dispenser device shown in FIG. 1a, demonstrating built-in protection against kinking of the drinking tube. As the adjustable feed tube is inserted into the drinking tube, a portion 25 of the drinking tube 26 that contains some of the adjustable feed tube 30 is reinforced (made of hardened material, or thicker, or provided with a reinforcing element) and is less prone to kinking that can cause blocking of the flow inside the tube or breaking of the tube.

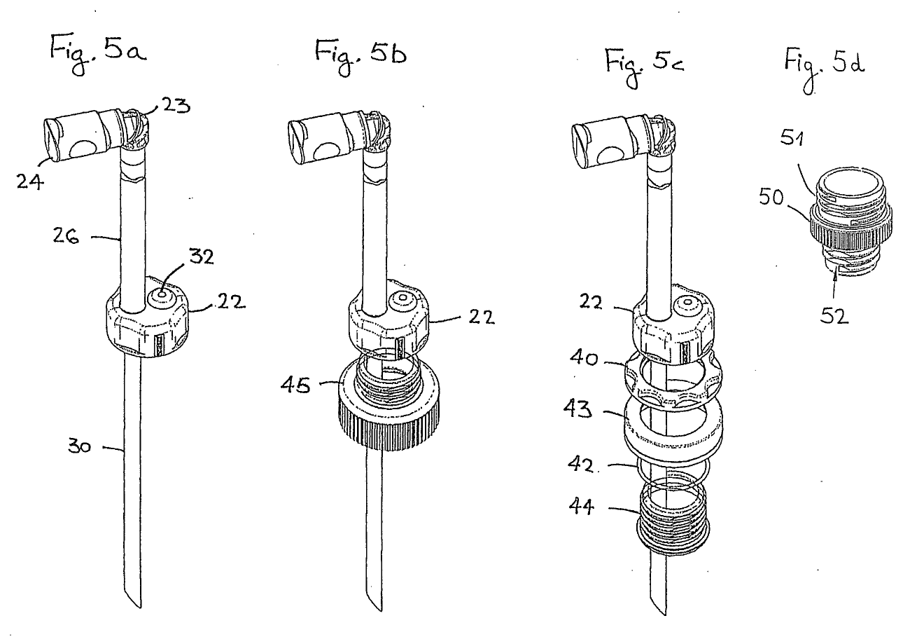

FIG. 3 illustrates a sectional view of a cap incorporated with a dispenser device according to a preferred embodiment of the present invention. The cap is provided with internal thread 34 (see FIG. 2a) to cooperate with corresponding external thread on the bottle neck. The cap is provided with an opening 35 from which a flange 36 is extended, onto which drinking tube 26 is fitted. Adjustable feed tube 30 is threaded through the flange 36 and into drinking tube 26. In order to reduce friction and allow the adjustable feed tube 30 to be moved in and out of the drinking tube 26, its external diameter is slightly smaller than the external diameter of the drinking tube. To prevent leaks or entry of air a sealing gasket 38 is provided (see FIG. 4c, which depicts the detail in FIG. 3 encircled by a small circle). This may be for example a tapered section of flange 36, an O-ring, a combination of both or any other means for effectively sealing the opening, yet allowing adjustable feed tube 30 to move in and out of drinking tube 26.

FIG. 4a illustrates a sectional view of an optional one-way valve 32 incorporated with the cap of a dispenser device according to a preferred embodiment of the present invention (the detail encircled by a large circle in FIG. 3). The one-way valve is designed to allow air into the interior of the bottle when sub-atmospheric pressure of a predetermined value is reached, caused by the drinking action that reduces internal pressure. The one-way valve shown in the figure comprises a conduit with opening facing the surrounding atmosphere and an internal end with a slit 33. The conduit is made of plastic, rubber, or other flexible material and this caters for the material caving out at the slit upon reaching predetermined threshold sub-atmospheric pressure within the bottle, allowing air to enter and equalizing pressures.

FIG. 4b illustrates detail of the cap shown in FIG. 5a, showing the one-way valve 32 and its slit 33.

FIG. 5a illustrates a cap 22 for a dispenser device according to a preferred embodiment of the present invention.

FIG. 6b illustrates a cap for a dispenser device according to a preferred embodiment of the present invention, with an adapter 45. The adapter is used to facilitate fitting the cap onto a bottle with a neck size that is different than the neck size the cap originally fits. Adapter 45 is provided with external threading 46 for fitting the into the threading 34 of the cap and an internal threading (not shown in this figure) for fitting onto an external threading of the neck of the bottle.

FIG. 5c illustrates an alternative adapter for use with a dispenser device according to a preferred embodiment of the present invention. This adapter includes a cap 43 that is larger than cap 22. Cap 43 is provided with an opening (punched or otherwise produced). A tightening ring 40 fits cap 22 to the opening of cap 43, an additional O-ring gasket is optionally provided. Other adapters 44 may also be coupled cooperatingly. This universal cap can be in fact provided as a kit together with the dispenser device of the present invention. Instead of a punched cap the kit may include several replacement caps and one or more punches for punching a hole in one (or more) of the replacement caps of the desired size.

In some preferred embodiments of the present invention the dispenser device is provided with several adapters fitting various sizes of bottle necks, so as to allow the user to reinstall the device on different bottles as desired.

FIG. 5d illustrates such an adapter 50. This adapter has one external threading 52 designed to fit an internal thread of a bottle neck, and opposite external thread 51 designed to fit internal thread of the cap of the device according to a preferred embodiment of the present invention.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A dispenser device for dispensing liquid form a bottle or container having a neck onto which a cap can be fitted, the device comprising:
a cap adapted to be fitted to the neck, the cap provided with an opening;
a drinking tube having a distal end and proximal end, the proximal end connected to the opening of the cap;
an adjustable feed tube having a proximal end and a distal end, the proximal end inserted into the proximal end of the drinking tube, the feed tube adapted to be moved at least partially in and out of the drinking valve and through the opening of the cap, so as to allow adjusting the length of the feed tube that is inserted inside the bottle.

2. The device of claim 1, wherein the drinking tube is provided drinking valve coupled to the distal end of the drinking tube.

3. The device of claim 1, wherein the cap is provided with a one-way valve for pressure release.

4. The device of claim 1, further provided with at least one adapter for connecting the cap to the neck.

5. The device of claim 4, wherein the adapter has an internal thread for fitting onto a corresponding external thread on the neck and an external thread for fitting into a corresponding internal thread of the cap.

6. The device of claim 4, wherein the adapter has an external thread for fitting into a corresponding internal thread on the neck and an external thread for fitting into a corresponding internal thread of the cap.

7. The device of claim 4, wherein a plurality of adapters designed for necks of different sizes is provided.

8. The device of claim 1, wherein the cap is provided with a flange extending over the opening on which the drinking tube is fitted.

9. The device of claim 1, wherein a portion of the drinking tube at the proximal end is reinforced so as to prevent kinking of the tube.

10. The device of claim 1, wherein a universal adapter is provided for connecting the cap to necks of different sizes.

11. The device of claim 10, wherein the universal adapter comprises at least one other cap with means for providing a hole in said at least one other cap for fitting with the cap.

12. The device of claim 11, wherein the means for providing a hole comprises one or more punches.
